(19) United States
(12) Patent Application Publication
(10) Pub. No.: US 2007/0292588 A1
(43) Pub. Date: Dec. 20, 2007

(54) FLUORESCENT BEVERAGE AND METHOD

(76) Inventors: Christopher J. Clements, Boulder City, NV (US); Adam Joseph Machado, Las Vegas, NV (US)

Correspondence Address: WEISS & MOY PC, 4204 NORTH BROWN AVENUE, SCOTTSDALE, AZ, 85251, US

(21) Appl. No.: 11/424,489

(22) Filed: Jun. 15, 2006

(51) Int. Cl. C12H 1/14

(52) U.S. Cl. 426/592

(57) ABSTRACT

A fluorescent beverage is provided in which one or more nontoxic and safe colored fluorescent dyes are added to a beverage. When exposed to ultraviolet light, the beverage will fluoresce or glow to create an attractive advertising display for the beverage. The beverage is preferably colorless. The beverage can be a spirit, drinking water, wine, beer, soda, gelatin, or the like. The fluorescent dyes are available in a variety of colors and forms. Depending on the form of the fluorescent dye and the intensity of the color desired, various amounts may be added to the beverage.

### FIELD OF THE INVENTION

The present invention relates generally to beverage displays and, more particularly, to a display of a fluorescent beverage and a method therefor.

### BACKGROUND OF THE INVENTION

The ability to attractively display beverages, for example in a bar or lounge setting, can contribute to the creation of a desired ambience and can also make the displayed beverages attractive for purchase, in effect, a form of advertisement. Presently, in such settings, such displays are often created using bottles of liquor presented in a setting involving the use of lights and/or mirrors.

A need exists for a display beverage and method that will permit a display of bottled beverages in a manner that is more unusual and more visibly pleasing to some patrons. The present invention satisfies these needs and provides other related advantages.

### SUMMARY OF THE INVENTION

A fluorescent beverage is provided. The beverage may be a clear liquid or a spirit. Mixed within the liquid is an amount of at least one fluorescent dye. The at least one fluorescent dye may be mixed directly into the liquid or it may be dissolved in a small amount of water or saline solution.

The beverage may be spirits, water, soda, gelatin, wine and beer. The preferred liquids are substantially colorless. The liquids may also be odorless and tasteless. The at least one fluorescent dye should be nontoxic and safe for ingestion. One color alone or in combination with other color(s) may be used. The color used may depend on the color of the liquid. Any color can be used in a clear liquid. If the liquid is not clear, the color(s) may be selected to provide the greatest contrast with the color of the liquid.

The range of volumes of liquid in which the at least one fluorescent dye is dispersed may vary depending on whether a strong or light visual concentration is desired. For example, for about 1000 ml to about 4000 ml of liquid, about 0.01 to about 0.06 g of powdered fluorescent dye or 0.01 ml to about 0.04 ml liquid fluorescent dye may be added to provide a strong visual concentration.

The fluorescent beverages may be exposed to UV light to cause the beverages to glow creating an attractive beverage display.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective environmental view of a fluorescent beverage within a bottle embodying the invention, illustrating a fluorescent dye being added to the bottled beverage; and

FIG. 2 is a perspective environmental view of the method of the invention, illustrating exposing the fluorescent beverage of FIG. 1 to ultraviolet light to make the fluorescent beverage glow in the dark

### DETAILED DESCRIPTION OF THE PREFERRED EMBODIMENTS

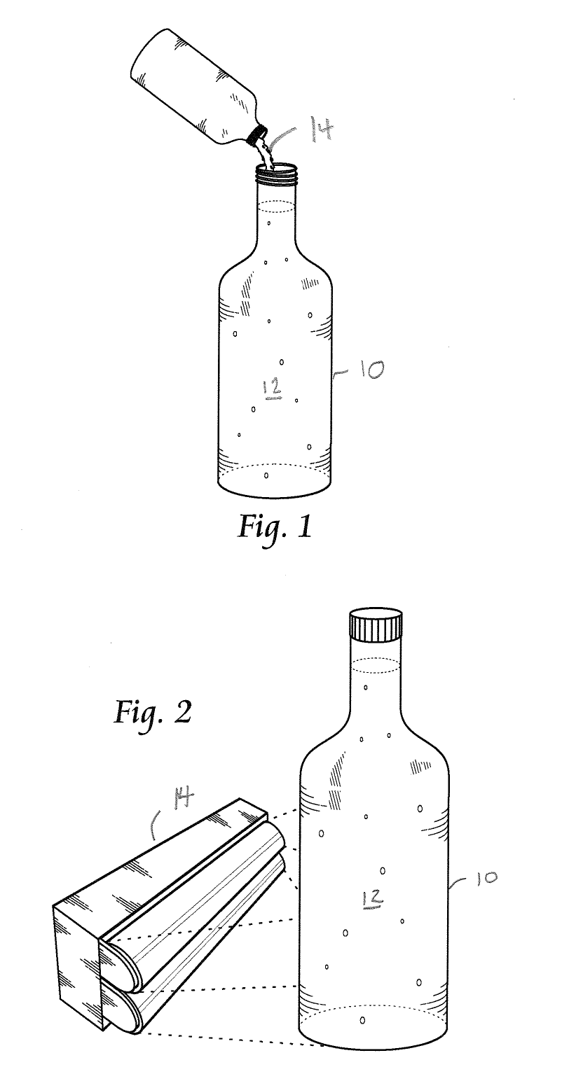

Referring first to FIG. 1, a beverage container 10 is shown. The container 10 contains a liquid 12, which may be a clear liquid or a spirit. Mixed within the liquid 12 is an amount of at least one fluorescent dye 14. The at least one fluorescent dye 14 may be mixed directly into the liquid or it may be dissolved in a small amount of water (not shown) or saline solution (not shown) as hereinafter described.

The liquid beverage 12 may be a spirit. Generally, a spirit is any alcoholic beverage that is not a wine or beer. Examples of spirits are brandy, gin, rum, vodka, and whiskey. Other suitable liquid beverages include water, soda, gelatin, wine, beer or the like. The preferred beverages are substantially colorless although colored beverages may be used. The liquids may also be odorless and tasteless (hereinafter referred to as “neutral liquids”). Such neutral beverages include vodka, white rums and white whiskies.

The at least one fluorescent dye should be nontoxic and safe for ingestion. Suitable dyes include disodium fluorescein (C20H10O5Na2) available from, for example, Flinn Scientific, P.O. Box 219, Batavia, Ill. 60510. Other suitable fluorescent dyes are available from, for example, Bright Dyes, Division of Kingscote Chemicals, 3334 S. Tech Blvd., Miamisburg, Ohio 45342.

The fluorescent dyes may be selected from a wide variety of colored fluorescent dyes. For example, red, orange and yellow/green fluorescent dyes are available from Bright Dyes. The specific fluorescent dyes available from Bright Eyes that are suitable include, but are not limited to the following:
Orange: FLT Orange Liquid Concentrate; FLT Orange Dye Tablet Chemical Name: Eosin Soda Salt; Chemical Family: (Xanthene Dye form)
Red: FWT Red 50 Liquid; FWT 200 Liquid (Xanthene Dye form)
Yellow/Green: FLT Yellow/Green Liquid Concentrate Chemical Family: Aqueous Dye Product) FLT Yellow/Green Powdered (Chemical Name: Disodium fluorescein; Chemical Family: Xanthene Dye Form)
   Of course, other colors and fluorescent dyes from other sources may be used. The fluorescent dyes should be suitable for drinking water. Any color may be used within the confines of the invention. One color alone or in combination with other color(s) may be used. The color used may depend on the color of the liquid. Any color can be used in a clear liquid. If the liquid is not clear, the color(s) may be selected to provide the greatest contrast with the color of the liquid. The fluorescent dye may appear as one color and under UV light as another color.

The fluorescent dyes may be available in a number of forms such as tablets, liquid, powder, or the like. The preferred form is powdered.

The fluorescent beverage may be made by mixing the at least one fluorescent dye vigorously with the clear liquid as shown by the examples below, which are not intended to be limiting.

### EXAMPLE ONE

4000 ml clear liquid
0.01-0.02 g powdered fluorescent dye

### EXAMPLE TWO

4000 ml clear liquid
Dissolve 0.01-0.02 g powdered fluorescent dye in 1 cc of either Sodium chloride or 1 cc of distilled water before mixing the dye with the liquid. Shake vigorously.

### EXAMPLE THREE

4000 ml clear liquid
Dissolve 0.2 g powdered fluorescent dye of one color and 0.2 g powdered fluorescent dye of another color in the clear liquid to produce a multi-color fluorescent beverage which is about half one color and half another color. Shake vigorously.

### EXAMPLE FOUR

4000 ml clear liquid
0.03-0.04 ml liquid fluorescent dye Shake vigorously.

The mixture may be heated to about 150° F. to improve solubility, if necessary. The range of volumes of liquid in which the at least one fluorescent dye is dispersed may vary depending on whether a strong or light visual concentration is desired. For example, for about 1000 ml to about 4000 ml of liquid, about 0.01 to about 0.6 g of powdered fluorescent dye or about 0.01 to about 0.04 ml liquid fluorescent dye may be added to provide a strong visual concentration. It is to be appreciated that a combination of liquid fluorescent dye and powdered fluorescent dye may be used. The preferred ratio of powdered dye to liquid is 1:400 i.e. 1 part dye to 400 parts liquid. For multi-color fluorescent beverages, two or more different-colored fluorescent dyes may be added to the beverage.

The method of displaying beverages in a dark place is also provided and comprises the steps of:

providing a fluorescent beverage;

exposing the fluorescent beverage to ultraviolet light from an external source.

The external source of the ultraviolet light may be from UV lamps 14, etc. Under UV light, the fluorescent beverage appears brightly colored and luminous i.e. the fluorescent beverage will fluoresce, or glow when exposed to the ultraviolet light (black light). These black lights are often seen in nightclubs or on stages. The external source of UV light is preferably within close range (about six to about 24 inches) of the fluorescent beverage, but may also be positioned a greater distance away.

From the foregoing, it is to be appreciated that the glowing beverage bottles create an attractive display and decorative effect, especially in a bar setting or club setting. They help create a desired unique ambience and can also make the displayed beverages attractive for purchase. The fluorescent beverages are substantially safe and non-toxic and will not adversely affect one's health. The flavor and texture of the beverage is substantially unaffected. The person's perspiration and urine may be tinted the color of the dye for a short period of time.

Although a particular embodiment of the invention has been described in detail for purposes of illustration, various modifications may be made without departing from the spirit and scope of the invention. Accordingly, the invention is not to be limited, except as by the appended claims.

We claim:

1. A fluorescent beverage comprising:
an ingestible liquid; and
at least one fluorescent dye dispersed in said liquid.

2. The fluorescent beverage of claim 1, wherein the at least one fluorescent dye is dissolved in one of saline solution and distilled water.

3. The fluorescent beverage of claim 1, wherein the ingestible liquid is colorless.

4. The fluorescent beverage of claim 3, wherein the fluorescent beverage is a spirit.

5. The fluorescent beverage of claim 4, wherein the fluorescent spirit is selected from the group consisting of brandy, gin, rum, vodka, and whiskey.

6. The fluorescent beverage of claim 1, wherein the ingestible liquid is selected from the group consisting of water, soda, wine, beer, and gelatin.

7. The florescent beverage of claim 1, wherein the at least one fluorescent dye is in powdered form in an amount between about 0.01 g and about 0.06 g per 1000-4000 ml of ingestible liquid.

8. The fluorescent beverage of claim 1, wherein the at least one fluorescent dye is in liquid form in about between about 0.01 ml and about 0.04 ml dispersed in about 1000 to about 4000 ml ingestible liquid.

9. The fluorescent beverage of claim 1, wherein two or more fluorescent dyes are dispersed in the ingestible liquid to produce a multi-colored fluorescent beverage.

10. The fluorescent beverage of claim 9, wherein two fluorescent dyes are dispersed in the ingestible liquid at a 1:1 ratio to produce a dual color fluorescent beverage.

11. A beverage display for a dark place, comprising:
one or more bottles of beverages arranged in a display;
at least one fluorescent dye dispersed in at least one of the one or more bottles of beverages in the beverage display.

12. The beverage display of claim 11, wherein the beverages are liquor and the bottles of beverages are bottles of liquor.

13. The beverage display of claim 12, wherein the liquor comprises at least one spirit.

14. The beverage display of claim 11, wherein at least one of the one or more bottles of beverages fluoresces when exposed to ultraviolet light.

15. The beverage display of claim 11, wherein at least one of the one or more bottles of beverages fluoresces in more than one color when exposed to ultraviolet light.

16. A display method for bottled colored fluorescent beverages, comprising the steps of:
providing a plurality of bottled colored fluorescent beverages; and
exposing said bottled fluorescent beverages to ultraviolet radiation from an external light source to cause said bottled colored fluorescent beverages to fluoresce.

17. The display method of claim 16, wherein said bottled colored fluorescent beverages comprise at least one spirit to which at least one fluorescent dye has been added.

18. The display method of claim 17, wherein the at least one spirit is colorless, tasteless and odorless.
